(19) United States
(12) Patent Application Publication
(10) Pub. No.: US 2013/0002984 A1
(43) Pub. Date: Jan. 3, 2013

(54) LIGHT CONTROL DEVICE AND IMAGE DISPLAY DEVICE

(75) Inventors: Hideki Uchida, Osaka-shi (JP); Tsuyoshi Kamada, Osaka-shi (JP); Satoshi Shibata, Osaka-shi (JP); Hidefumi Yoshida, Osaka-shi (JP)

(73) Assignee: Sharp Kabushiki Kaisha, Osaka-shi, Osaka (JP)

(21) Appl. No.: 13/520,346

(22) PCT Filed: Oct. 28, 2010
(86) PCT No.: PCT/JP2010/069200

§ 371 Date: Sep. 17, 2012

(30) Foreign Application Priority Data
Jan. 7, 2010 (JP) 2010-002302

(51) Int. Cl. G02F 1/13357; F21V 8/00

(52) U.S. Cl. 349/65; 362/613

(57) ABSTRACT

A light control device is provided which (i) controls an arbitrary area on a plane to emit light and (ii) can suppress a crosstalk. A light control device (1) of the present invention includes: a light guide plate (2), having rectangular parallelepiped light guide paths juxtaposed to each other, for guiding light entered an edge of a shorter side of the light guide path, in a longer side direction of the light guide paths; LEDs (3), provided at the respective edges, for emitting lights toward the respective light guide paths; and light-passage amount adjusting means for adjusting ratios of light-passage amount of the light guide plate (2). The light-passage amount adjusting means (i) is provided on a light exit surface side of the light guide plate (2) and (ii) has rectangular parallelepiped switching elements (4) which allow ratios of light-passage amount of the light guide plate (2) to be adjustable. The switching elements (4), juxtaposed to each other in the longer side direction, each extends in a direction perpendicular to the longer side direction.

### TECHNICAL FIELD

The present invention relates to a light control device and an image display device including the light control device.

### BACKGROUND ART

Conventionally, a display device included in a device such as a television, a monitor, or a mobile phone includes a backlight for backlighting a display panel so that an image is displayed on the display panel. Such a backlight can be roughly classified into, for example, a direct type backlight and a side-edge type backlight, depending on difference in how light is emitted.

In the direct type backlight, a plurality of light sources are arranged in a matrix manner, and the plurality of light sources are separately controlled to emit partial lights. FIG. 18 is a view illustrating a configuration of a conventional direct type backlight. In a direct type backlight 30 (see (a) of FIG. 18), a plurality of LED chips 31, which serve as light sources, are arranged in a matrix manner. According to the configuration, the plurality of LED chips 31 are separately controlled to be turned ON or OFF so that light is emitted from an arbitrary area. According to the configuration, however, the plurality of LED chips 31 are provided behind the display panel, and therefore shadows of the plurality of LED chips 31 are cast on the display panel. According to the backlight 30, it is therefore necessary to sufficiently secure a distance between a diffusing plate 32 and the plurality of LED chips 31 (as indicated by an allow of (b) of FIG. 18). This causes the backlight 30 itself to become thicker, and accordingly a display device including the backlight 30 cannot have a thin body.

According to a side-edge type backlight, a light source provided on a lateral side of a light guide plate emits light toward inside of the light guide plate so that the light is emitted outside from the light guide plate. FIG. 19 is a view illustrating a configuration of a conventional side-edge type backlight. According to the side-edge type backlight 50, light is emitted from a light source 52 provided on a lateral side of a light guide plate 51, and the light is subjected to a total reflection while being guided in the light guide plate 51 (see FIG. 19). The light guide plate 51 has a light exit surface having a structure for intentionally preventing such a total reflection so that light can be emitted outside. According to the configuration, although the side-edge type backlight can be thinner than the direct type backlight, it is difficult to provide a configuration for preventing a total reflection of light, and it is also difficult to control emission of light. With the configuration, therefore, it is difficult to control light to be partially emitted from an arbitrary area.

Meanwhile, a technique has been conceived in which liquid crystal is used as a switching element for enabling a side-edge type backlight to partially emit light from an arbitrary area. Such a technique is disclosed in, for example, Patent Literatures 1 through 5. According to prior art, a light-passage amount is controlled by utilizing anisotropy of liquid crystal molecules (see FIG. 20). FIG. 20 is a view schematically illustrating orientation of liquid crystal molecules.

Patent Literature 6 discloses a scan backlight which controls lighting for each area. FIG. 21 is a view illustrating a configuration of the scan backlight. According to an illumination device of Patent Literature 6, a backlight 116, which is provided behind a display panel, includes a light guide plate 114 made up of a plurality of blocks (114a through 114e) (see FIG. 21). LEDs 111, each of which is white or a set of RGB, are provided at respective end parts of the plurality of blocks of the light guide plate 114. The LEDs 111 are separately controlled to emit light or the LEDs 111 are controlled to emit light for each group of some LEDs 111. Lighting locations are scanned in sync with locations of a display panel into which locations an image is to be written. Subsequently, each of pixel rows of the display panel is rewritten, and an LED 111, which is provided for the each of pixel rows, is controlled to emit light, after a predetermined period of time is elapsed, so that an image is displayed. Such a technique relating to the scan backlight is disclosed also in Patent Literatures 7 and 8.

Patent Literature 9 discloses a backlight made up of a plurality of strip-shaped members in which backlight line modulation is carried out by changing an intensity of emitted light for each of the strip-shaped members.

### CITATION LIST

### Patent Literatures

### [Patent Literature 1]

International Publication No. WO2006/104159 (Publication date: Oct. 5, 2006)

### [Patent Literature 2]

International Publication No. WO2006/104160 (Publication date: Oct. 5, 2006)

### [Patent Literature 3]

Japanese Patent Application Publication Tokukaisho No. 59-58421 A (Publication date: Apr. 4, 1984)

### [Patent Literature 4]

Japanese Patent Application Publication Tokukai No. 2000-171813 A (Publication date: Jun. 23, 2000)

### [Patent Literature 5]

Japanese Patent Application Publication Tokukaisho No. 63-116121 A (Publication date: May 20, 1988)

### [Patent Literature 6]

Japanese Patent Application Publication Tokukai No. 2001-210122 A (Publication date: Aug. 3, 2001)

### [Patent Literature 7]

Japanese Patent Application Publication Tokukai No. 2008-53614 A (Publication date: Sep. 4, 2008)

### [Patent Literature 8]

Japanese Patent Application Publication Tokukai No. 2009-69751 A (Publication date: Apr. 2, 2009)

### [Patent Literature 9]

Japanese Patent Application Publication Tokukai No. 2004-206044 A (Publication date: Jul. 22, 2004)

### SUMMARY OF INVENTION

### Technical Problem

Note, however, that, in a case where liquid crystal is used as a switching element of a side-edge type backlight, light sometimes passes through an area which is not intended to pass the light through. In a case where an electric current is applied to a target liquid crystal element in an arbitrary area so that the target liquid crystal element is driven, a phenomenon called “crosstalk” sometimes occurs in which the electric current leaks around the target liquid crystal element and therefore other liquid crystal elements are driven by the leaked electric current. In such a case, contrast of an image is decreased because the image is displayed in a blurred state where light is emitted from an unintended area. However, Patent Literatures 1 through 5 do not specifically disclose how liquid crystal is driven, and the problem of crosstalk is not mentioned neither. It is therefore impossible to sufficiently suppress a crosstalk.

The scan backlights disclosed in Patent Literatures 6 through 8 and the backlight disclosed in Patent Literature 9 cannot control a two-dimensional area, i.e., an arbitrary area on a plane, and therefore light cannot be partially emitted by the configurations disclosed in Patent Literatures 6 through 9.

The present invention is accomplished in view of the problem, and its object is to provide a light control device which (i) controls an arbitrary area on a plane to emit light and (ii) can suppress a crosstalk.

### Solution to Problem

In order to attain the object, a light control device of the present invention includes: light guide means, which has a plurality of light guide paths (i) each of which has a rectangular parallelepiped shape and (ii) which are juxtaposed to each other, for guiding light, which has entered an end part on a side of a shorter side of each of the plurality of light guide paths, in a longer side direction of the each of the plurality of light guide paths; a plurality of light sources, provided at the respective end parts, for emitting lights toward the respective plurality of light guide paths; and light-passage amount adjusting means for adjusting ratios of light-passage amount of the light guide means, the light-passage amount adjusting means (i) being provided on a light exit surface side of the light guide means and (ii) having a plurality of elements which allow ratios of light-passage amount of the light guide means to be adjustable, the plurality of elements (a) each having a rectangular parallelepiped shape, (b) each extending in a direction perpendicular to the longer side direction, and (c) being juxtaposed to each other in the longer side direction.

According to the configuration, the light control device of the present invention includes (i) the light guide means, which has the plurality of light guide paths each of which has (a) the rectangular parallelepiped shape and (b) the end part at which a corresponding one of the plurality of light sources is provided and (ii) the plurality of elements (a) which allow ratios of light-passage amount to be adjustable, (b) each of which extends in the direction perpendicular to the longer side direction, and (c) which are juxtaposed to each other in the longer side direction. With the configuration, it is possible to control an arbitrary area on a plane to emit light.

Specifically, the light guide means has the plurality of light guide paths (i) each of which has the rectangular parallelepiped shape, (ii) which are juxtaposed to each other, and (iii) each of which has the end part at which a corresponding one of the plurality of light sources is provided. Moreover, the light-passage amount adjusting means is provided on the light exit surface side of the light guide means. The light-passage amount adjusting means has the plurality of elements (i) which allow ratios of light-passage amount to be adjustable, (ii) each of which has the rectangular parallelepiped shape, (iii) each of which extends in the direction perpendicular to the longer side direction, and (iv) which are juxtaposed to each other in the longer side direction. With the configuration, the plurality of light sources are controlled to emit respective lights, and the plurality of elements are controlled to adjust the ratios of light-passage amount, so that lights are emitted via the plurality of elements.

Here, (i) the plurality of light sources, which are provided for the respective plurality of light guide paths, can be controlled separately and (ii) the plurality of elements can also be controlled separately. With the configuration, it is possible to control amounts of respective lights, which are emitted, via the plurality of elements, from the respective plurality of light guide paths corresponding to the respective plurality of light sources, by, for example, controlling the plurality of light sources to emit lights having respective different intensities or to emit lights for respective different periods of time. Meanwhile, it is possible to control amounts of lights, which are emitted via the respective plurality of elements, by controlling the plurality of elements to have respective different ratios of light-passage amount.

According to the light control device of the present invention, the plurality of light sources are thus provided for the respective plurality of light guide paths so as to be separately controlled, and the plurality of elements are also thus provided so as to be separately controlled. With the configuration, it is possible to (i) control the plurality of light sources to emit lights, having respective arbitrary light intensities, toward the respective plurality of light guide paths and (ii) control the plurality of elements to have respective arbitrary ratios of light-passage amount. It is thus possible to emit lights from arbitrary areas on a plane by synchronizing (i) a timing at which the plurality of light sources emit respective lights and (ii) a timing at which the lights pass through the plurality of elements.

According to the light control device of the present invention, the plurality of elements, through which light can pass, are separately provided for respective lines, and the plurality of light guide paths for guiding respective lights are also separately provided for respective lines. As such, in a case where only a certain light source, provided for a certain light guide path intersecting an area in an arbitrary line from which area light is to be emitted, is controlled to emit light on a condition that a certain element of the arbitrary line is controlled so that lights can pass through, light will not leak out of a peripheral area, even if an electric current leaks out to reach the peripheral area when the element is driven. This is because light sources are turned off. Since the plurality of elements are provided for respective separated lines, an electric current of an element hardly leaks out to reach adjacent elements of respective adjacent lines. According to the present invention, it is possible to reduce a crosstalk.

### Advantageous Effects of Invention

The light control device of the present invention includes: light guide means, which has a plurality of light guide paths (i) each of which has a rectangular parallelepiped shape and (ii) which are juxtaposed to each other, for guiding light, which has entered an end part on a side of a shorter side of each of the plurality of light guide paths, in a longer side direction of the each of the plurality of light guide paths; a plurality of light sources, provided at the respective end parts, for emitting lights toward the respective plurality of light guide paths; and light-passage amount adjusting means for adjusting ratios of light-passage amount of the light guide means, the light-passage amount adjusting means (i) being provided on a light exit surface side of the light guide means and (ii) having a plurality of elements which allow ratios of light-passage amount of the light guide means to be adjustable, the plurality of elements (a) each having a rectangular parallelepiped shape, (b) each extending in a direction perpendicular to the longer side direction, and (c) being juxtaposed to each other in the longer side direction. This makes it possible to provide the light control device which (i) controls an arbitrary area on a plane to emit light and (ii) can suppress a crosstalk.

### BRIEF DESCRIPTION OF DRAWINGS

FIG. 1 is a top view illustrating a configuration of a light control device, in accordance with an embodiment of the present invention.

FIG. 2 is a cross sectional view illustrating a configuration of a light control device, in accordance with an embodiment of the present invention.

FIG. 3 is a cross sectional view illustrating a configuration of a switching element, in accordance with an embodiment of the present invention.

FIG. 4 is a view illustrating how an LED is modulated, in accordance with an embodiment of the present invention.

FIG. 5 is a view illustrating a driving pattern of a light control device, in accordance with an embodiment of the present invention.

FIG. 6 is a cross sectional view illustrating a configuration of an image display device, in accordance with an embodiment of the present invention.

FIG. 7 is a view illustrating an example of an image displayed on a liquid crystal display.

FIG. 8 is a top view illustrating a configuration of a light control device, in accordance with another embodiment of the present invention.

FIG. 9 is a view illustrating a driving pattern of a light control device, in accordance with Embodiment 2 of the present invention.

FIG. 10 is a view illustrating a light emitting pattern on a light emitting surface.

FIG. 11 is a view illustrating a driving pattern of the light control device of Embodiment 2.

FIG. 12 is a cross sectional view illustrating a configuration of another switching element.

FIG. 13 is a top view illustrating a configuration of a light control device, in accordance with another embodiment of the present invention.

FIG. 14 is a top view illustrating a configuration of a light control device, in accordance with another embodiment of the present invention.

FIG. 15 is a top view illustrating a configuration of a light control device, in accordance with another embodiment of the present invention.

FIG. 16 is a view illustrating a configuration of another switching element.

FIG. 17 is a view illustrating a configuration of another switching element.

FIG. 18 is a view illustrating a configuration of an LED direct type backlight.

FIG. 19 is a view illustrating a configuration of a conventional side-edge type backlight.

FIG. 20 is a view schematically illustrating anisotropy of liquid crystal molecules.

FIG. 21 is a view illustrating a configuration of a backlight of a conventional illumination device.

### DESCRIPTION OF EMBODIMENTS

### Embodiment 1

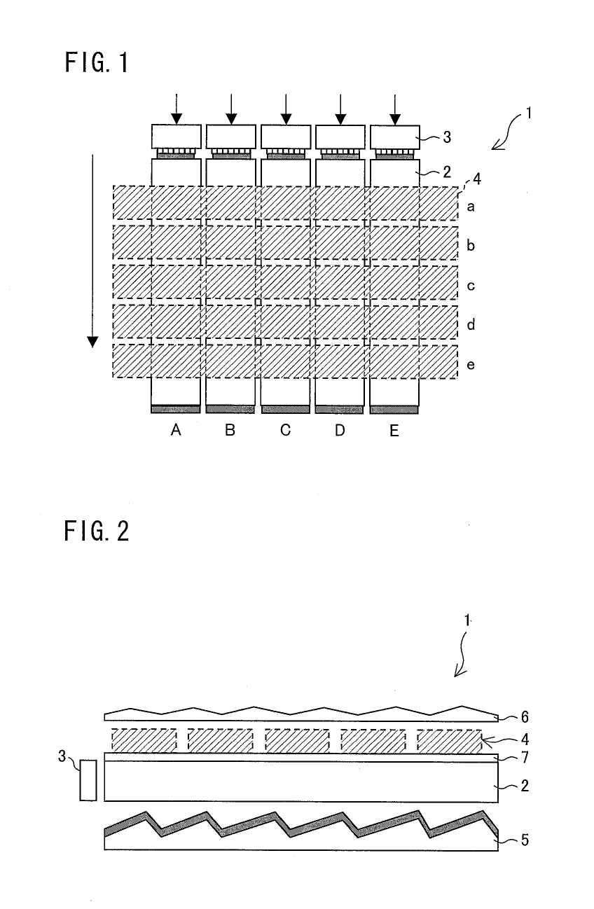

The following description will discuss Embodiment 1 of the present invention, with reference to FIGS. 1 through 17. First, the following description will discuss a configuration of a light control device 1 in accordance with Embodiment 1, with reference to FIG. 1.

(Configuration of Light Control Device 1)

FIG. 1 is a top view illustrating a configuration of the light control device 1. The light control device 1 includes a plurality of light guide plates (light guide means) 2, a plurality of LEDs (light source) 3, and a plurality of switching elements (element) 4 (see FIG. 1).

The light control device 1 of Embodiment 1 is a side-edge-type light control device in which passage of light can be controlled for each of a plurality of areas. According to the light control device 1, each of the plurality of light guide plates 2 has a rectangular parallelepiped shape, and the plurality of LEDs 3 are provided at end parts of the respective plurality of light guide plates 2. The plurality of switching elements 4 are juxtaposed to each other in a longer side direction of the plurality of light guide plates 2, and each of the plurality of switching elements 4 extends in a direction perpendicular to the longer side direction. Each of the plurality of switching elements 4 can adjust a ratio of light-passage amount.

Specifically, the plurality of light guide plates 2, each of which has a rectangular parallelepiped shape, (i) are juxtaposed to each other and (ii) have respective end parts where the respective plurality of LEDs 3 are provided. The plurality of switching elements 4, (i) each of which has a rectangular parallelepiped shape and (ii) which can adjust the ratio of light-passage amount, are provided on a light exit surface side of the plurality of light guide plates 2. The plurality of switching elements are juxtaposed to each other in the longer side direction of the plurality of light guide plates 2, and each of the plurality of switching elements 4 extends in the direction perpendicular to the longer side direction. With the configuration, it is possible to direct, outward via the plurality of switching elements 4, lights which have been emitted from the plurality of LEDs 3, by adjusting ratios of light-passage amount of the respective plurality of switching elements 4.

Note that it is possible to (i) separately control the plurality of LEDs 3 which are provided for the respective plurality of light guide plates 2 (ii) separately control the plurality of switching elements 4. With the configuration, it is possible to control amounts of respective lights, which are to be emitted from the plurality of LEDs 3 via the respective plurality of light guide plates 2, by, for example, controlling the plurality of LEDs 3 to emit lights having respective different light intensities or to emit lights for respective different periods of time. It is further possible to control the amounts of respective lights, which pass through the respective plurality of switching elements 4, by differently changing the ratios of light-passage amounts of the respective plurality of switching elements 4.

According to the light control device 1, the plurality of LEDs 3 are thus provided for the respective plurality of light guide plates 2 so as to be separately controlled, and the plurality of switching elements 4 are also thus provided so as to be separately controlled. With the configuration, it is possible to (i) control the plurality of LEDs 3 to emit lights, having respective arbitrary light intensities, toward the respective plurality of light guide plates 2 and (ii) control the plurality of switching elements 4 to have respective arbitrary ratios of light-passage amount. As such, it is possible to emit lights from arbitrary areas on a plane, by synchronizing (i) a timing at which the plurality of LEDs 3 emit respective lights and (ii) a timing at which the lights pass through the plurality of switching elements 4.

According to the light control device 1, the plurality of switching elements 4, through which light can pass, are separately provided for respective lines, and the plurality of light guide plates 2 for guiding respective lights are also separately provided for respective lines. As such, in a case where only a certain LED 3, provided for a certain light guide plate 2 intersecting an area of an arbitrary line from which area light is to be emitted, is controlled to emit light on a condition that a certain switching element 4 of the arbitrary line is controlled so that lights can pass through, light will not leak out of a peripheral area, even if an electric current leaks out to reach the peripheral area. This is because LEDs 3 adjacent to the certain LED 3 are turned off. Since the plurality of switching elements 4 are provided for respective separated lines, an electric current of a switching element 4 hardly leaks out to reach adjacent switching elements 4 of respective adjacent lines. According to Embodiment 1, it is possible to reduce a crosstalk.

Note that the “arbitrary area on a plane” in this specification intends to mean an arbitrary area on a light emitting surface of the light control device 1, which light emitting surface is specified by combining the plurality of light guide plates 2 and the plurality of switching elements 4. The rectangular areas in which the plurality of light guide plates 2 are provided are also referred to as respective “lines,” and the rectangular areas in which the plurality of switching elements 4 are provided are also referred to as respective “lines.” The plurality of light guide plates 2 correspond to respective lines A through E, and the plurality of switching elements 4 correspond to respective lines a through e (see FIG. 1).

Each of the plurality of light guide plates 2 is not limited in particular, provided that each of the plurality of light guide plates 2 guides entered light. A shape of each of the plurality of light guide plates 2 is not limited to a particular one, provided that the plurality of light guide plates 2, each having a rectangular parallelepiped shape (see FIG. 1), are juxtaposed to each other. Each of the plurality of light guide plates 2 has an end part, on a side of a shorter side, where a corresponding one of the plurality of LEDs 3 is provided. This causes each of the plurality of light guide plates 2 to guide light, which has entered from its shorter side, in its longer side direction.

A material of each of the plurality of light guide plates 2 is not limited to a particular one, provided that the material guides light. Examples of the material of each of the plurality of light guide plates 2 encompass an acrylic plate, polyurethane resin, polycarbonate resin, PMMA (Polymethyl methacrylate), and PVA (Polyvinyl alcohol). Alternatively, each of the plurality of light guide plates 2 can be made of glass. The number of the plurality of light guide plates 2 is not limited to a particular one, and therefore the number of the plurality of light guide plates 2 can be set as appropriate in accordance with a factor such as a size of the light control device 1. Intervals at which the plurality of light guide plates 2 are provided are not limited to particular ones. In a case where the light control device 1 is used as, for example, a backlight of an image display device, the intervals at which the plurality of light guide plates 2 are provided can be set as appropriate in accordance with intervals at which a plurality of pixels are provided in a display panel. In a case where a single light guide plate, which has a plurality of light guide paths, is employed instead of the plurality of light guide plates 2 (e.g., in a case where a plurality of light sources are provided at any of edges of a square light guide plate), intervals at which the plurality of light guide paths are provided can be set as appropriate, in a manner similar to the case where the plurality of light guide plates 2 are employed.

Each of the plurality of LEDs 3 is a light source for emitting light. As above described, the plurality of LEDs 3 are provided at the respective end parts on the shorter side of the respective plurality of light guide plates 2. Examples of the plurality of LEDs 3 encompass a white LED and a set of red, green, and blue LEDs. Note that the light source of the light control device 1 is not limited to the plurality of LEDs 3. Examples of the light source encompass inorganic EL devices and organic EL devices. Each of such light emitting elements is a surface emitting element, and therefore has the advantage of being provided in accordance with a size of a corresponding one of rectangular cross sections. The light source of the light control device 1 can be a surface emitting light source or a point emitting light source.

Each of the plurality of LEDs 3 preferably emits light having directivity which causes the light to propagate in a longer side direction of a corresponding one of the plurality of light guide plates 2. Note that, in this case, a single light guide plate can be employed instead of the plurality of light guide plates 2. As long as the plurality of LEDs 3 emits light having such directivity, the lights, which (i) have been emitted from the respective plurality of LEDs 3 and (ii) have entered such a single light guide plate, travel in a longer side direction of the single light guide plate, even in a case of the single light guide plate, that is, even in a case where the plurality of LEDs 3 are not demarcated for each of a plurality of lines. This makes it possible to provide the plurality of light guide paths which are juxtaposed to each other.

Each of the plurality of switching elements 4 is not limited to a particular one, provided that it can adjust light transmittance of the switching element 4. For example, the plurality of switching elements 4, each having a rectangular parallelepiped shape, can be provided (i) so as to be juxtaposed, on the light exit surface side of the plurality of light guide plates 2, to each other in a longer side direction of the plurality of light guide plates 2 and (ii) so as to extend in the direction perpendicular to the longer side direction (see FIG. 1). Note that the plurality of switching elements 4 are provided on a substrate. On the substrate (light-passage amount adjusting means), (i) the plurality of switching elements 4, each having rectangular parallelepiped shape, can be separately provided so as to be juxtaposed to each other as described in Embodiment 1 or (ii) a single plate, on which the plurality of switching elements 4 are juxtaposed to each other, can be provided.

Examples of a material of the substrate encompass acryl, glass, PET (polyethylene terephthalate), PEO (polyethylene oxide), and TAC (triacetylcellulose).

A method of switching the plurality of switching elements 4 is not limited to a particular one. Examples of the method encompass (i) a method in which light is emitted outside by utilizing a change in refractive index of a light guide plate 2 and (ii) a method in which a mechanical shutter is used. Specifically, passage of light can be controlled by use of a method, like a conventional method using liquid crystal, in which method light is passed or blocked by changing orientations of liquid crystal molecules depending on whether or not a voltage is applied across the liquid crystal. Alternatively, passage of light can be controlled by using elements prepared by an MEMS (Micro Electro Mechanical System) method.

The number of the plurality of switching elements 4 is not limited to a particular one, and therefore the number of the plurality of switching elements 4 can be set as appropriate in accordance with a factor such as a size of the light control device 1. Intervals, at which the plurality of switching elements 4 are provided, are not limited to particular ones. In a case where, for example, the light control device 1 is employed as a backlight of an image display device, a size of each of the plurality of switching elements 4 can be set as appropriate in accordance with the number of areas into which a display panel is divided.

The light control device 1 preferably includes control means (not illustrated) for controlling the plurality of LEDs 3 and the plurality of switching elements 4. The control means can control, for example, a driving pattern of the plurality of LEDs 3 and a driving pattern of the plurality of switching elements 4. Note that the controlling, carried out by the control means, will be described later in detail.

The light control device 1 preferably includes a reflecting plate (reflecting means) or a scattering plate (scattering means), which is provided on a surface opposite to the light emitting surface, i.e., on surfaces of the respective plurality of light guide plates 2, which surfaces are opposite to the light exit surfaces of the plurality of light guide plates 2. FIG. 2 is a cross sectional view illustrating a configuration of the light control device 1. According to the light control device 1, a reflecting plate 5 is provided behind the light guide plate 2 (see FIG. 2). This allows light, which has been emitted from the light guide plate 2 toward the surface opposite to the light emitting surface, to be reflected from the reflecting plate 5 and then be directed toward a light emitting surface side. Alternatively, in a case where the scattering plate is provided, light, which has been emitted toward the surface opposite to the light emitting surface, enters the scattering plate, is scattered by the scattering plate, enters the surface opposite to the light emitting surface, and is then emitted toward the light emitting surface side. This allows an improvement in efficiency of light emission.

According to the light control device 1, (i) a diffusing plate 6 for diffusing light is provided above the plurality of switching elements 4, i.e., on the light emitting surface side, and (ii) matching oil 7 is provided between (a) the plurality of light guide plates 2 and (b) the plurality of switching elements 4 (see FIG. 2). The matching oil 7 serves to cause the plurality of light guide plates 2 and the plurality of switching elements 4 to have identical refractive indexes. This allows light guided in the plurality of light guide plates 2 to be emitted toward the plurality of switching elements 4.

A measure for obtaining the identical refractive indexes is not limited to the provision of the matching oil. Alternatively, the plurality of light guide plates 2 and the plurality of switching elements 4 can have refractive indexes identical to a refractive index of (i) an adhesive via which an upper substrate is adhered to a lower substrate or (ii) a bonding agent via which the upper substrate is bonded to the lower substrate. Alternatively, a resin, whose refractive index is similar to those of (a) the plurality of light guide plates 2 and (b) the plurality of switching elements 4, can be provided between the plurality of light guide plates 2 and the plurality of switching elements 4. In a case where, for example, upper and lower substrates having a refractive index of 1.5 is used, aGEL (registered trademark) (manufactured by Taica Corporation) can be employed. Alternatively, the plurality of light guide plates 2 and the plurality of switching elements 4 can have identical refractive indexes by thermally fusing areas where the plurality of light guide plates 2 and the plurality of switching elements 4 overlap each other.

(Configuration of Switching Element 4)

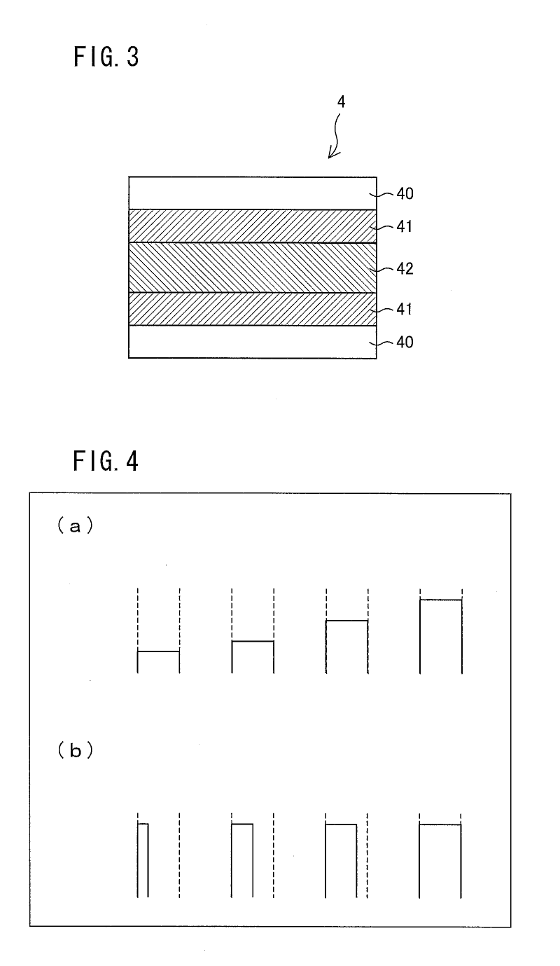

FIG. 3 is a cross sectional view illustrating a configuration of each switching element 4. The switching element 4 of Embodiment 1 includes two substrates 40, two transparent electrodes 41, and a liquid crystal layer 42 which is provided between the two transparent electrodes 41. The two transparent electrodes 41 are provided so as to be located between the two substrates 40 (see FIG. 3). As such, the switching element 4 (i) is configured so as to include upper and lower electrodes (hereinafter, referred to as upper-lower electrode structure) and (ii) carries out switching by use of liquid crystal. According to the light control device 1, the plurality of switching elements 4 are provided for the respective separated plurality of lines. This allows a reduction in crosstalk, even though each of the plurality of switching elements 4 has the upper-lower electrode structure.

According to an upper-lower electrode structure, since upper and lower electrodes are arranged in a matrix manner, guided wave light is emitted outside from an arbitrary area on a plane (i.e., an area in which an upper electrode and a lower electrode, which are being driven, overlap each other). Since such an upper-lower electrode structure is a simple matrix structure, a crosstalk can be caused. Although the light control device 1 of Embodiment 1 has the electrodes arranged in a simple matrix manner, the plurality of switching elements 4 are separately provided for the respective plurality of lines. This allows a crosstalk to be suppressed.

The liquid crystal layer 42 of Embodiment 1 is a polymer dispersed liquid crystal layer, which contains (i) liquid crystal materials whose orientation states are changed depending on an electric field and (ii) a polymer material which is mixed with the liquid crystal materials so as to surround the liquid crystal materials. A polymer dispersed liquid crystal is prepared by uniformly dispersing liquid crystal materials in a polymer material. The polymer dispersed liquid crystal is switched between a light scattering state and a transparent state, depending on whether or not to apply a voltage across the polymer dispersed liquid crystal. In the light scattering state, orientation vectors of the dispersed liquid crystal materials are directed in different directions, and therefore light is scattered in an interface. This causes the polymer dispersed liquid crystal to be in an opaque white state. That is, entered light comes out from the switching element 4. On the other hand, in the transparent state, the dispersed liquid crystal materials are oriented in identical directions, and therefore the polymer material and the liquid crystal materials have substantially identical refractive indexes with respect to light. In this state, the light travels without being scattered. That is, the entered light does not come out from the switching element 4.

Note that it is possible to arbitrarily design whether the light scattering state or the transparent state is obtained depending on whether a voltage is applied across the polymer dispersed liquid crystal, or vice versa. Since Embodiment 1 includes the matching oil 7, light guided in the light guide plate 2 is guided along a light guide path and is not emitted outside while no electric field is applied across the polymer dispersed liquid crystal. On the other hand, while an electric field is being applied across the polymer dispersed liquid crystal, the liquid crystal layer 42 becomes in the light scattering state and therefore light which has entered the switching element 4 is scattered and directed outside. This is because a waveguide condition is no longer met. The light is thus emitted via the light emitting surface. In a case where polymer dispersed liquid crystal, having such properties, is employed, it is not necessary to provide a polarizing plate or an alignment plate. It is therefore possible to realize an optical shutter which operates with less electric power consumption and with high light use efficiency.

In a case where, for example, polymer dispersed liquid crystal is used as the liquid crystal material, examples of the polymer dispersed liquid crystal encompass PDLC (Polymer Dispersed Liquid Crystal) and PNLC (Polymer Network-Liquid Crystal). The PDLC is prepared by dispersing droplets of liquid crystal in a polymer obtained by hardening a solution in which liquid crystal molecules and polymeric resin are uniformly contained. In the PNLC, a polymer, prepared by hardening a solution in which liquid crystal molecules and polymeric resin are uniformly contained, forms a three-dimensional network in a liquid crystal layer. In the PNLC, the liquid crystal molecules are arranged irregularly.

Meanwhile, reverse type polymer dispersed liquid crystal becomes a transparent state while a voltage is being applied across the polymer dispersed liquid crystal. Reverse mode (anisotropic gel) polymer dispersed liquid crystal can be prepared by (i) mixing several percent of a polymerizable polymer in nematic liquid crystal, (ii) injecting the nematic liquid crystal into a liquid crystal cell which has been subjected to a rubbing treatment, and (iii) irradiating the liquid crystal cell with ultraviolet after liquid crystal molecules have been oriented. Reverse mode (a composite of UV-curable liquid crystal and nematic liquid crystal) polymer dispersed liquid crystal can be prepared by (i) mixing PDLC and PNLC together and (ii) irradiating the mixture with ultraviolet light after liquid crystal molecules have been oriented.

It is possible to employ, as liquid crystal material, a material which has birefringence Δn higher than that of a polymer material. An acrylate material can be employed as the polymer material.

The following description will discuss how to prepare the switching element 4. First, a transparent electrode material is deposited on a first substrate 40 by sputtering so that a first transparent electrode 41 is formed on the first substrate 40. Then, polymer dispersed liquid crystal is applied onto the first transparent electrode 41. Examples of a substrate 40 encompass an acrylic substrate.

Examples of a material of the transparent electrode 41 encompass (i) inorganic materials such as ITO (indium tin oxide), IZO (transparent electrode material made of indium oxide and zinc oxide), and FTO (fluorine-doped tin oxide) and (ii) organic materials such as PEDOT-PSS (poly(3,4-ethylenedioxythiophene) poly(styrenesulfonate)).

Then, a second transparent electrode 41 is similarly formed on a second substrate 40 by depositing the transparent electrode material on the second substrate 40 by sputtering. The first and second substrates 40 thus prepared are (i) combined and hardened such that the first and second transparent electrodes 41 are located between the first and second substrates 40, respectively. Examples of a hardening method encompass an ultraviolet hardening. Note, however, that the hardening method is not limited to this. The switching element 4 is thus prepared.

(Driving Pattern in Light Control Device 1)

As early described, in the light control device 1, a driving pattern of the plurality of LEDs 3 and a driving pattern of the plurality of switching elements 4 can be controlled by the control means.

When the control means controls the driving patterns, it is preferable to (i) sequentially control the plurality of LEDs 3 to emit respective lights and (ii) adjust, during the controlling of the plurality of LEDs 3, ratios of light-passage amount of the respective plurality of switching elements 4. This causes the control means sequentially to control the plurality of LEDs 3 such that the plurality of LEDs 3 emit lights one by one, instead of controlling all the plurality of LEDs 3 to concurrently emit respective lights. This allows prevention of decrease in contrast.

In a case where, for example, all the plurality of LEDs 3 are controlled to concurrently emit their respective lights, light is guided to an area which is not a target area from which light comes out. In such a case, light sometimes slightly leaks out of such an area because the ratios of light-passage amount of the respective plurality of switching elements 4 are not sufficiently adjusted. On the other hand, in the case where only any one of the plurality of LEDs 3 emits light, light hardly leaks out of an area which is not a target area from which light comes out, even in a case where the ratios of light-passage amount of the respective plurality of switching elements 4 are not sufficiently adjusted. This allows an improvement (i) in contrast and (ii) in light use efficiency.

According to the light control device 1, it is necessary that only any of the plurality of LEDs 3 be controlled, instead of adjusting intensities of lights emitted from the respective plurality of LEDs 3. It is therefore possible that all the plurality of LEDs 3 emit respective lights of identical intensities. In a case where, for example, an LED is used as a light source, it is necessary to prepare an expensive electric current control mechanism for adjusting intensity of light. Since all the plurality of LEDs 3 are necessary to emit respective lights of identical intensities, it is possible to simplify an electric current control mechanism for the plurality of LEDs 3. This allows a reduction in cost.

Alternatively, when the control means controls the driving patterns, it is preferable to (i) sequentially control the plurality of switching elements 4 so as to adjust the ratios of light-passage amount and (ii) control all the plurality of LEDs 3 to emit respective lights during controlling of the plurality of switching elements 4. This causes the control means to (i) sequentially control the plurality of switching elements 4 such that the ratios of light-passage amount of the respective plurality of switching elements 4 are adjusted one by one and (ii) control all the plurality of LEDs 3 to emit respective lights, instead of concurrently adjusting all the ratios of light-passage amount of the respective plurality of switching elements 4. Namely, the plurality of LEDs 3 are controlled to emit lights having respective intensities which vary depending on light exit areas, while the plurality of switching elements 4 are sequentially being controlled to adjust the ratios of light-passage amount.

In a case where, for example, (i) a first switching element 4, which is being controlled, has a ratio of light-passage amount of 100% and (ii) a second switching element 4, which is not being controlled, has a ratio of light-passage amount of 0%, light exit areas on a line corresponding to the first switching element 4 are determined depending on intensities of lights emitted from the respective plurality of LEDs 3. Specifically, in a case where (i) a ratio of light-passage amount of a switching element 4 corresponding to the line b (illustrated in FIG. 1) is controlled to be 100% and (ii) lights are intended to be emitted from only areas at respective intersections of the line b and the lines B and D of respective light guide plates 2, the control means (i) controls only LEDs 3 corresponding to the lines B and D to emit respective lights and (ii) controls the other LEDs 3 corresponding to the lines A, C, and E not to emit respective lights. This makes it possible to achieve a high contrast. The lights, emitted from the LEDs 3 corresponding to the respective lines B and D, are thus emitted outside only via the switching element 4 which is being controlled. This makes it possible to achieve high light use efficiency.

In the case where the plurality of switching elements 4 are sequentially driven, the ratios of light-passage amount adjusted by the control means are not limited to 0% and 100%. Note, however, that adjustable ratios of light-passage amount of all the plurality of switching elements 4 are preferably identical to each other. An order in which the plurality of switching elements 4 are sequentially controlled is not limited to a particular one. For example, the plurality of switching elements 4, which are juxtaposed to each other, can be sequentially controlled from top to bottom, as indicated by an arrow of FIG. 1. A relative ratio between respective intensities of lights emitted from the plurality of LEDs 3 is not limited to 0 and 100. The plurality of LEDs 3 can therefore be controlled to emit lights with respective target intensities.

Note that it is preferable that the control means sequentially controls the plurality of switching elements 4 on a cycle corresponding to 60 Hz or longer. In this specification, a cycle on which a screen is rewritten, i.e., an interval between (i) writing into a pixel and (ii) rewriting into the pixel is referred to as “frame.” According to the configuration, the plurality of switching elements 4 are sequentially controlled on an extremely short cycle, i.e., at a speed equivalent to 60 frames per second. As such, even though light exit areas on the light emitting surface are gradually changed, a human cannot visually recognize such gradual changes. Instead, the light emitting surface seems to emit light with arbitrary brightness and does not appear odd.

In the case where the plurality of switching elements 4 are sequentially controlled, the control means preferably controls the plurality of LEDs 3 to continuously emit lights, during controlling of the plurality of LEDs 3, having respective intensities identical to those of lights emitted from the respective plurality of light guide plates 2. With the configuration, lights emitted from the plurality of light guide plates 2 have respective intensities which are identical with those of lights emitted from the respective plurality of LEDs 3. In this case, the intensities of lights emitted from the respective plurality of LEDs 3 can be controlled, for example, by controlling electric currents of the respective plurality of LEDs 3. (a) of FIG. 4 illustrates an example of controlling of the intensities. Note that FIG. 4 illustrates examples of how to control the intensities of lights emitted from the respective plurality of LEDs 3. Bars in a bar graph illustrated in (a) of FIG. 4 indicate respective electric currents. By thus controlling the electric currents, it is possible to control the plurality of LEDs 3 to emit lights having respective desired intensities.

In the case where the plurality of switching elements 4 are sequentially controlled, the control means preferably controls the plurality of LEDs 3 to continuously emit lights having identical intensities for respective time periods which vary depending on intensities of lights emitted from the respective plurality of light guide plates 2. According to the configuration, the plurality of LEDs 3 emit lights having identical intensities, and time periods, during which the respective lights are continuously emitted, are adjusted so that lights emitted from the plurality of LEDs 3 correspond to the intensities of lights emitted from the respective plurality of light guide plates 2. In this case, the intensities of lights emitted from the respective plurality of LEDs 3 can be controlled, for example, by pulse-width modulation.

According to the pulse-width modulation, an interval between light emitting frames of an LED 3 is subjected to time-division so as to adjust emission amounts of light (see (b) of FIG. 4). In (b) of FIG. 4, widths of bars of a bar graph indicate respective time periods during which light is emitted in one (1) frame period. The LED 3 has high-speed response, and is therefore suitable for time division driving. The pulse-width modulation has a control system which is less complicated than that of electric current driving. This allows a reduction in cost of the control system.

According to the light control device 1, one of the plurality of LEDs 3 and the plurality of switching elements 4 are thus sequentially driven and the others are controlled in accordance with the sequential driving. With the configuration, it is possible for an arbitrary area of the light emitting surface to emit light with an arbitrary intensity. It is further possible to cause light emitted from an LED 3 to concentrate on an area from which light is intended to be emitted. This allows the light to be emitted efficiently. Furthermore, it is possible to prevent an LED 3 from emitting light, which LED 3 corresponds to an area from which light is intended not to be emitted. This allows an improvement in contrast between bright and dark.

(Method of Driving Light Control Device 1)

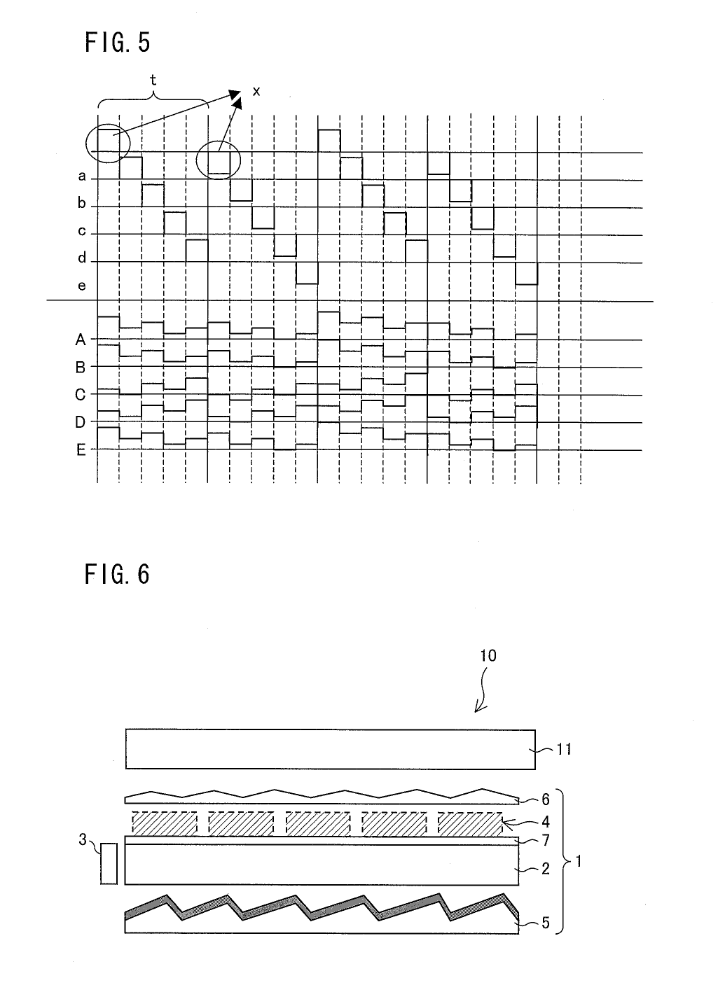

The following description will discuss how to drive the light control device 1, with reference to FIG. 5. FIG. 5 is a view illustrating a driving pattern of the light control device 1. In FIG. 5, (i) an upper part indicates a driving pattern in the lines a through e corresponding to the respective plurality of switching elements 4 and (ii) a lower part indicates a driving pattern in the lines A through E corresponding to the respective plurality of light guide plates 2.

Note that the following description will discuss, as an example, a driving method in which (i) the plurality of switching elements 4 are sequentially driven at a speed equivalent to 60 frames per second (see a range indicated by “t” in FIG. 5) and (ii) intensities of lights emitted from all the respective plurality of LEDs 3 are controlled.

First, the plurality of switching elements 4 are sequentially driven at a speed equivalent to 60 frames per second. In this case, (i) it takes 16.6 milliseconds for one (1) frame to be driven and (ii) it takes 3.7 milliseconds of one (1) line to be driven. The plurality of switching elements 4 are sequentially turned ON (e.g., controlled to have ratios of light-passage amount of 100%) from the line a to the line e. As early described, each of the plurality of switching elements 4 of Embodiment 1 is a liquid crystal type switching element. Under the circumstances, voltages are applied to the respective plurality of switching elements 4 so that the plurality of switching elements 4 have respective states in which liquid crystal is maximally scattered.

A voltage to be applied is not limited to a particular one, and can therefore be adjusted as appropriate. In Embodiment 1, a voltage of 100 V is applied across the polymer dispersed liquid crystal of each of the plurality of switching elements 4. Note that the polymer dispersed liquid crystal employed in Embodiment 1 has a scattering state which is saturated when a voltage of 60 V is applied. It follows that the polymer dispersed liquid crystal can have a sufficient scattering state while the voltage of 100 V is being applied, even in a case where the voltage is distorted. In order to prevent burn-in in the plurality of switching elements 4, it is necessary to adjust timings of controlling the plurality of switching elements 4 such that (i) +100 V and −100 V are alternately applied across the polymer dispersed liquid crystal and (ii) positive electric field caused by +100 V and negative electric field caused by −100 V always become an equilibrium state. In FIG. 5, areas indicated by “x” indicate reversal of polarity of the applied voltage 100 V. That is, a polarity of voltage to be applied to each of the plurality of switching elements 4 is reversed for each frame.

In sync with the selecting of the lines a through e of the sequentially driven plurality of switching elements 4, intensities of lights of the plurality of LEDs 3 corresponding to the respective lines A through E are adjusted. In a case where, for example, (i) a switching element 4 corresponding to the line a is turned ON and (ii) the plurality of light guide plates 2 corresponding to the respective lines A through E, which intersect the line a, are intended to emit lights having a continued luminance ratio of (0: 100: 200: 0: 500), the plurality of LEDs 3 corresponding to the respective lines A through E emit lights having respective intensities which vary depending on the continued luminance ratio (see FIG. 5). This allows the line a to emit lights having respective intended intensities.

Note that, in this case, switching elements 4 corresponding to the respective lines b through e are turned OFF, that is, have ratios of light-passage amount of 0%. No light is therefore emitted from the lines b through e. Subsequently, the lines b through e are sequentially controlled in a similar manner, and the plurality of LEDs 3 emit lights having respective required intensities to the respective lines A through E. It is thus possible to arbitrarily emit light(s), having an intended luminance(s), from area(s) in a matrix arrangement of 5×5. Since the plurality of switching elements 4 are sequentially controlled at a speed equivalent to 60 frames per second, the areas in the matrix arrangement of 5×5, as a whole, are viewed as lighting at an arbitrary brightness.

(Configuration of Image Display Device 10)

The light control device 1 of Embodiment 1 can be employed as a backlight of an image display device 10. FIG. 6 is a cross sectional view illustrating a configuration of the image display device 10 which includes the light control device 1 of Embodiment 1.

The image display device 10 further includes a display panel 11 which is provided on a light exit surface side of the light control device 1 (see FIG. 6). The display panel 11 is not limited to a particular one. Examples of the display panel 11 encompass a liquid crystal display (liquid crystal display panel). In such a case, the light control device 1 can be provided behind a TFT liquid crystal module of a liquid crystal display included in the image display device 10, and the TFT liquid crystal module can be driven in sync with driving of the plurality of switching elements 4.

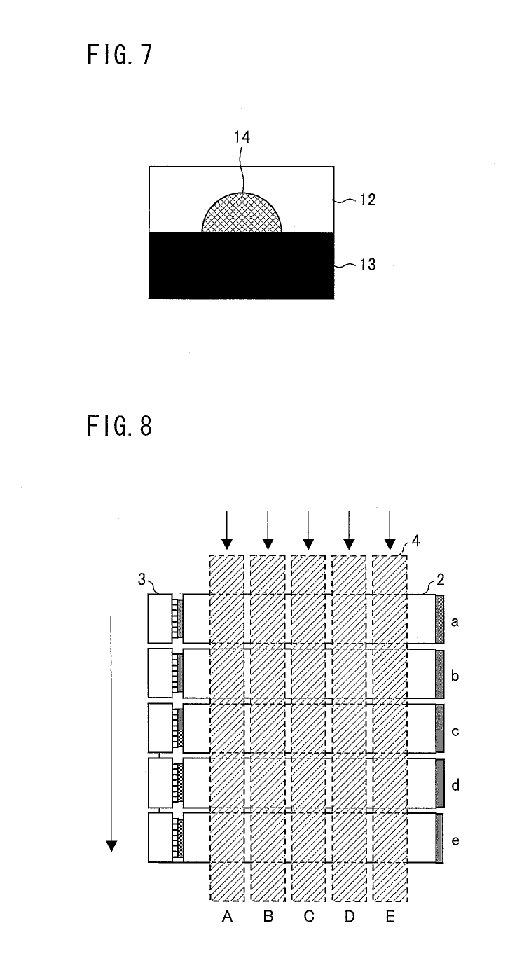

A light emitting pattern of the light control device 1 can be adjusted in accordance with an image to be displayed on the display panel 11. FIG. 7 illustrates an example of an image to be displayed on the display panel 11.

In a case where the display panel 11 displays an image of scenery of the setting sun (see FIG. 7), an upper part 12 of the image is bright, a lower part 13 of the image is dark, and a setting sun 14 in the center part of the image has a medium tone between the bright and the dark. In a case of a conventional image display device, a backlight backlights even a dark area of a displayed image. As such, even though light is blocked in the dark area by a switching mechanism, the light slightly leaks out, and therefore a black image in the dark area cannot be sufficiently displayed in black. On the other hand, according to the image display device 10 of Embodiment 1, it is possible to control an LED(s) 3 of the light control device 1 not to emit light(s) toward a dark area of a display image. This allows black to be deepened, and therefore allows an improvement in contrast.

The light control device 1 serves as a side emission type backlight. It is therefore unnecessary to sufficiently secure a space between a light emitting surface and LEDs, unlike a conventional LED direct type active backlight. It is necessary for the conventional LED direct type active backlight to secure a thickness of, for example, approximately 3 cm. On the other hand, it is necessary for the light control device 1 to secure a thickness of not thicker than 5 mm. As such, it is possible to provide an extremely thin backlight, as compared with a conventional direct type backlight. By employing such an extremely thin backlight (i.e., the light control device 1), it is possible to drastically reduce a thickness of the image display device 10.

In a case where an active driving is carried out, for example, with respect to areas in the matrix arrangement of 5×5 (i.e., 25 areas), the conventional direct type backlight is required to control 25 LEDs for controlling the respective 25 areas. On the other hand, the light control device 1 needs to control only (i) five lines of the switching elements 4 and (ii) five lines of the light guide plates 2 (the LEDs 3). In particular, in a case where the plurality of switching elements 4 are sequentially controlled, it is merely necessary to control the switching elements 4 to be turned ON or OFF. According to the configuration of Embodiment 1, merely the respective plurality of LEDs 3, corresponding to the respective lines A through E, are substantially controlled without using any complicated mechanism. This allows a reduction in cost of the light control device 1, which employs a simple control system. Note that a similar effect can be brought about in a case where the plurality of LEDs 3 are sequentially controlled.

### Embodiment 2

The following description will discuss Embodiment 2 of the present invention, with reference to FIG. 8. FIG. 8 is a top view illustrating a configuration of a light control device 1 of Embodiment 2. For convenience, the same reference numerals are given to constituents which are the same as those of Embodiment 1.

According to Embodiment 2, (i) a plurality of light guide plates 2 are provided along respective lines a through e each of which extends in a horizontal direction and (ii) a plurality of switching elements 4 are provided along respective lines A through E each of which extents in a vertical direction (see FIG. 8). According to the light control device 1 of Embodiment 2, a plurality of LEDs 3 are sequentially driven.

In the case where the plurality of LEDs 3 are sequentially driven, the plurality of LEDs 3 are controlled to emit respective lights having identical intensities. In such a case, it is not necessary to provide an electric current control mechanism, even though the plurality of LEDs 3 are employed as light sources. It is therefore possible to simplify an LED driving system. This allows a reduction in cost.

The following description will discuss a driving pattern of the light control device 1 of Embodiment 2.

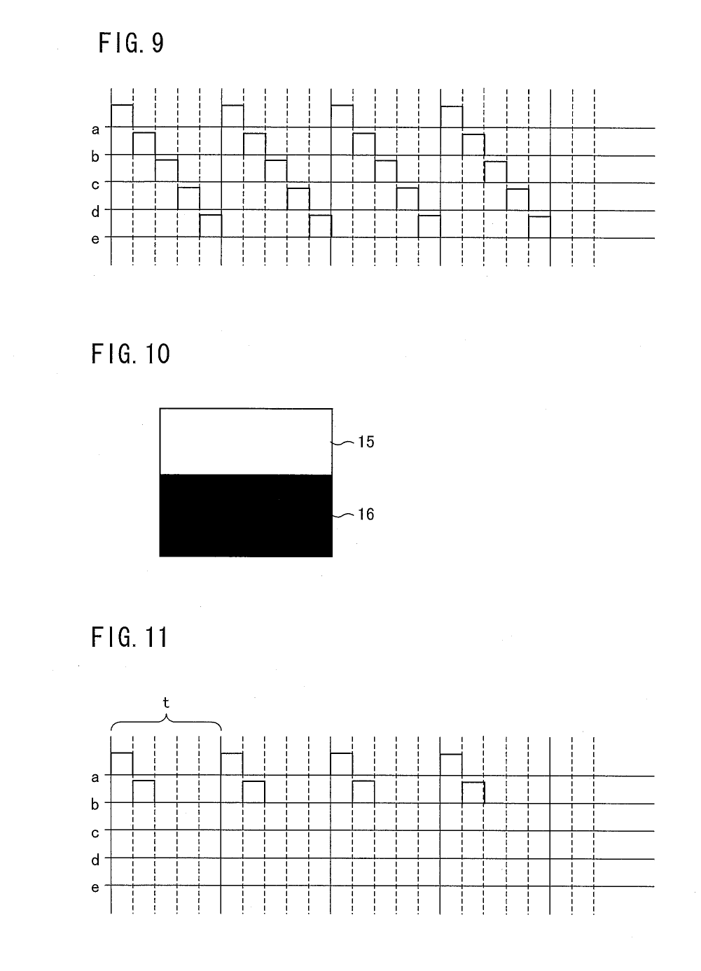

FIG. 9 is a view illustrating how the constituents are driven in the light control device 1 of Embodiment 2. According to a driving pattern illustrated in FIG. 9, lights are guided in all the respective plurality of light guide plates 2 provided in the lines a through e.

The light emitting surface can sometimes have a light emitting pattern in which almost no light exit area exists above any of the lines a through e as illustrated in FIG. 10. FIG. 10 is a view illustrating a light emitting pattern on the light emitting surface. According to the light emitting pattern illustrated in FIG. 10, the light control device 1 of Embodiment 2 can carry out a control in which (i) only LEDs 3 are sequentially driven which correspond to ones of the lines a through e directly below a light exit area 15 and (ii) the other LEDs 3 are not driven which correspond to the other of the lines a through e directly below a dark area 16 which has no light exit area.

Specifically, (i) only LEDs 3 are sequentially driven, which correspond to the respective lines a and b directly below the light exit area 15 and (ii) LEDs 3 are not driven, which correspond to the respective lines c through e directly below the dark area 16 (see FIG. 11). Note that FIG. 11 is a view illustrating how the constituents are driven in the light control device 1 of Embodiment 2. In the case where the dark area 16, i.e., a black display, extends in a direction along the lines c through e, it is possible to obtain a complete black display by causing the LEDs 3 corresponding to the lines c through e not to emit respective lights. This allows (i) an improvement in contrast and (ii) a reduction in power consumption.

### Embodiment 3

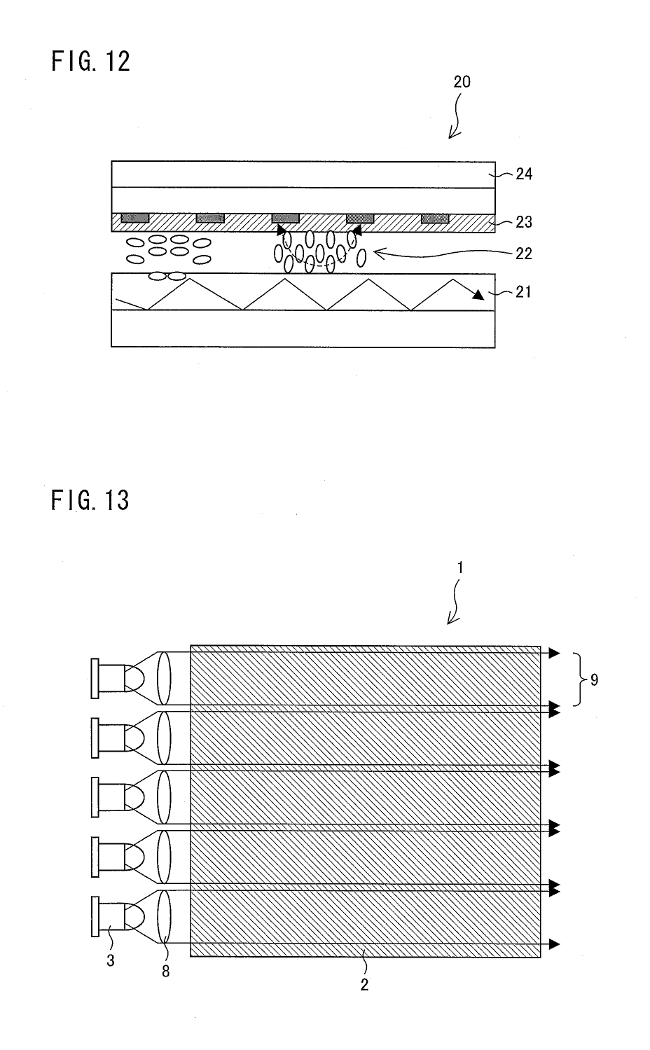

The following description will discuss Embodiment 3 of the present invention, with reference to FIG. 12. FIG. 12 is a cross sectional view illustrating a configuration of a switching element 20.

The switching element 20 of Embodiment 3 has a plane electrode structure (see FIG. 12). Specifically, the switching element 20 includes a light guide plate 21 and a diffusing plate 24 between which a liquid crystal layer 22 and a transparent electrode 23 are provided. That is, the switching element 20 includes only one transparent electrode 23, unlike the configuration in which the liquid crystal layer 21 is provided between the two electrodes.

According to the configuration of Embodiment 1, light guided in the light guide plate 2 is to enter the switching element 4, and accordingly passes through the transparent electrodes 41 which absorb visible light. In a case where light emitted from the light guide plate 2 passes through the transparent electrode 41 a number of times, transmittance (in general, approximately 90%) of the transparent electrode 41 will be reduced. Such a reduction in transmittance is accentuated especially in a large light control device 1. The configuration of Embodiment 1 employs the upper-lower electrode structure, and therefore the transmittance of the transparent electrode 41 is likely to be reduced.

On the other hand, the switching element 20, which is provided above a light exit surface side of the light guide plate 2, has the plane electrode structure. With the configuration, it is possible to reduce a probability that light emitted from the light guide plate 2 is absorbed by the transparent electrode 41, even though transmittance of the transparent electrode 41 is reduced. Note that, even in the case where the switching element 20 has the plane electrode structure, liquid crystal becomes a scattering state when an electric field is applied across the liquid crystal, as with the configuration of Embodiment 1.

Note that the switching element 20 is preferably provided so as to be away from the light guide plate 2 by a predetermined distance. With the configuration, it is possible to further reduce the probability that light is absorbed by the transparent electrode 23. This allows a sufficient luminance to be maintained.

### Embodiment 4

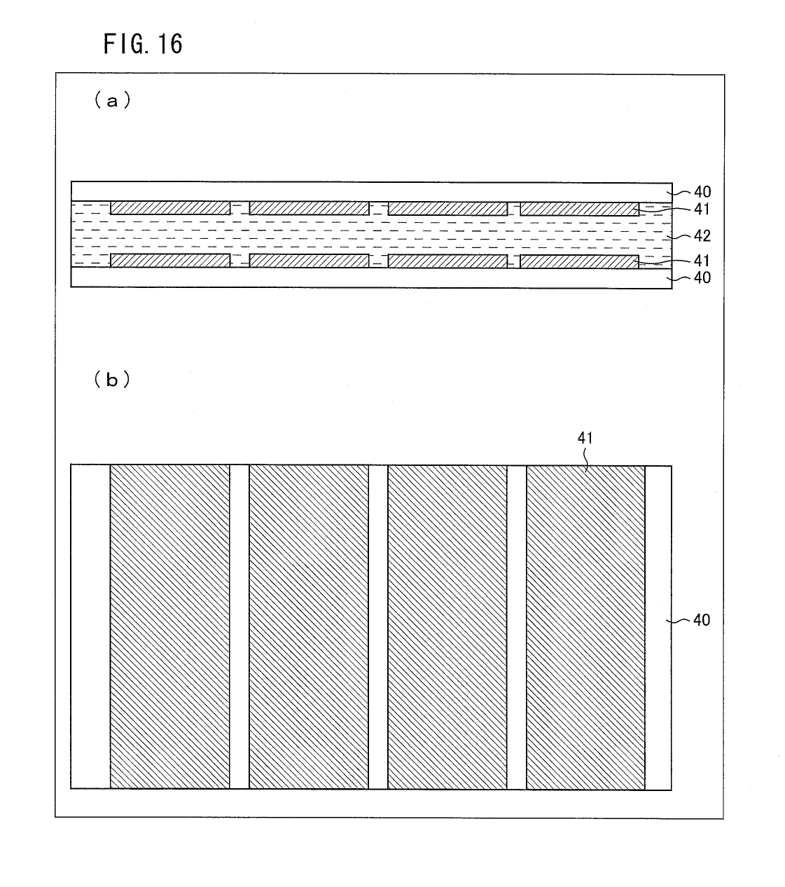

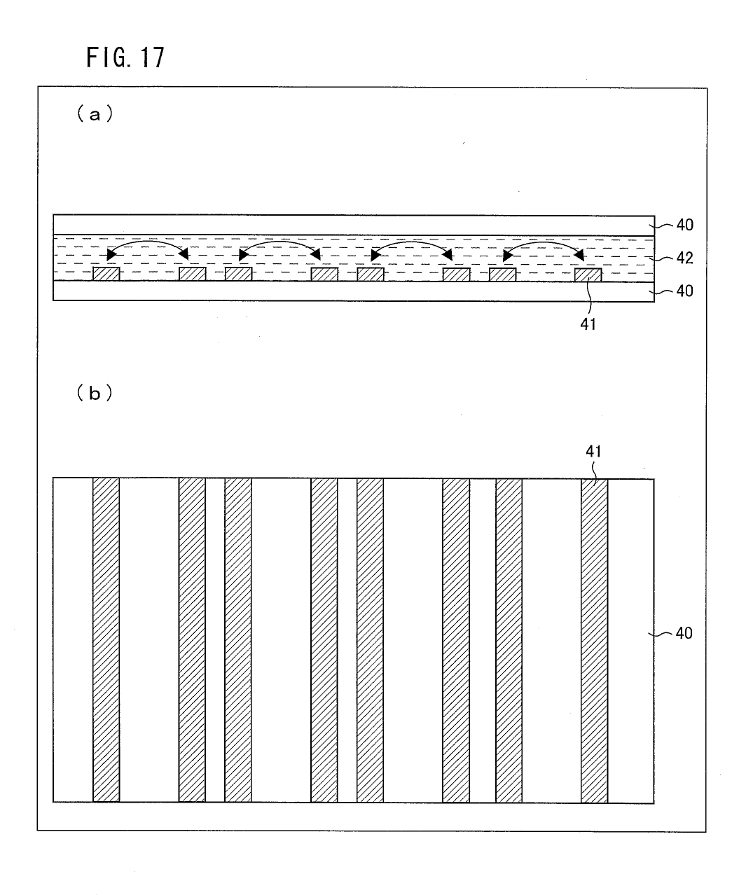

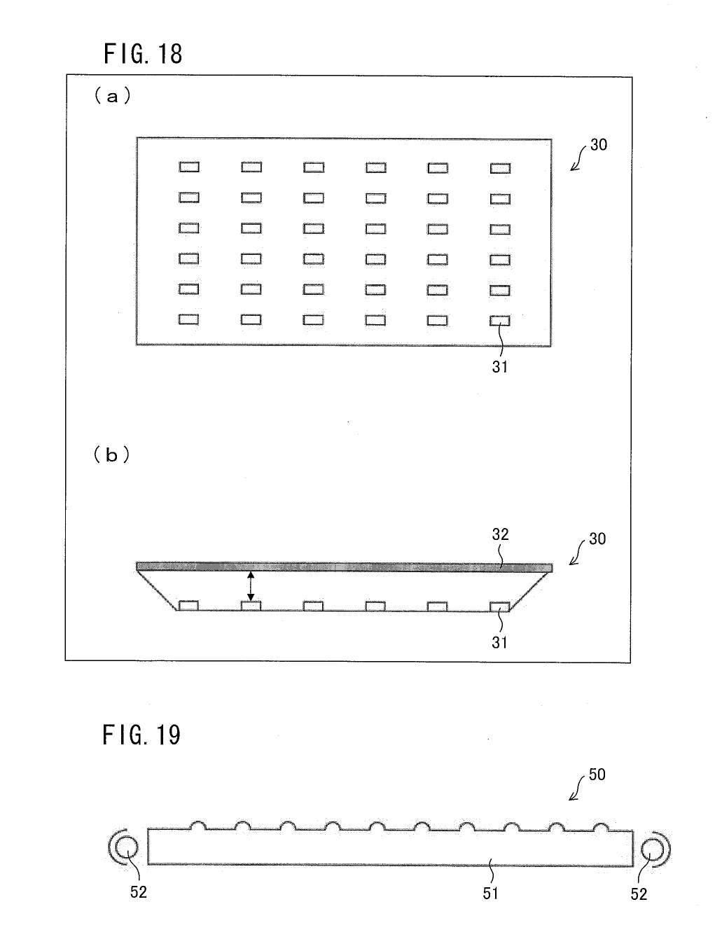

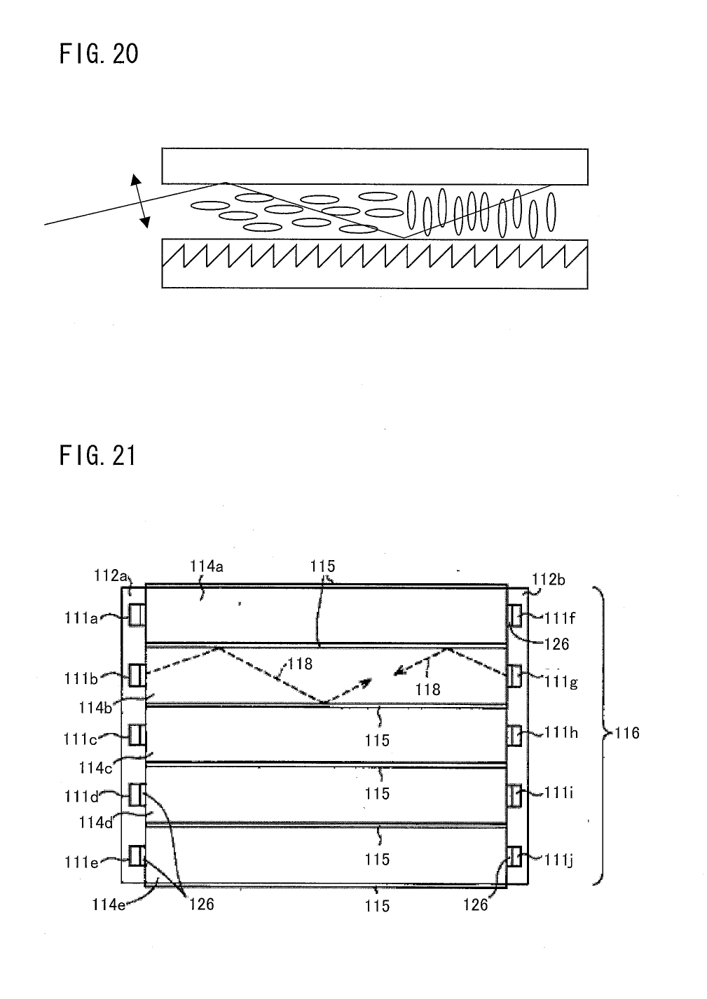

The following description will discuss Embodiment 4 of the present invention, with reference to FIGS. 13 through 17. Each of FIGS. 13 through 15 is a top view illustrating a configuration of a light control device of Embodiment 4. FIGS. 16 and 17 are views illustrating configurations of respective different switching element.

According to Embodiment 4, a single light guide plate 2 is employed, unlike the early described configurations in which the plurality of light guide plates 2, each having the rectangular parallelepiped shape, are juxtaposed to each other. Specifically, in a light control device 1 of Embodiment 4, (i) a plurality of LEDs 3 are provided at an end part of the single light guide plate 2, which has a square shape when viewed from above and (ii) a lens 8 is provided between the respective plurality of LEDs 3 and the single light guide plate 2 (see FIG. 13).

According to the configuration, each of the plurality of LEDs 3 emits light which has directivity. As such, the lights emitted from the respective plurality of LEDs 3 can be linearly guided in the light guide plate 2, even though the single light guide plate 2 is employed. Since the lens 8 is provided between the respective plurality of LEDs 3 and the light guide plate 2, it is possible to easily form parallel lights 9 of FIG. 13.

Note that the plurality of LEDs 3, each of which emits light having such directivity, is not limited to a particular one. Examples of the plurality of LEDs 3 encompass a commercially available collimated LED such as IBF-LS60 series (manufactured by IMAC Co., Ltd.). Such a collimated LED can emit light with a directional illuminating angle of approximately 10 degrees.

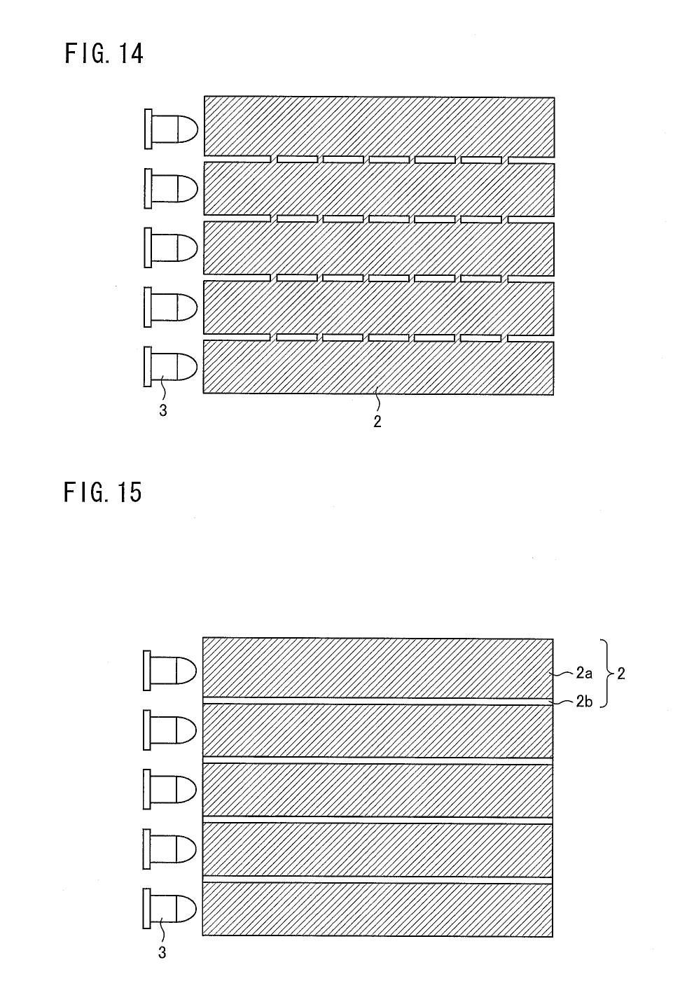

According to another example of a configuration in which only a single light guide plate 2 is provided, the light guide plate 2 has slits for demarcating lines in the light guide plate 2 (see FIG. 14). With the configuration, lights can be guided substantially linearly.

Alternatively, it is possible to define light guiding areas in a single light guide plate 2 by providing a line 2b between respective adjacent two lines 2a which correspond to the respective light guiding areas in the single light guide plate 2 (see FIG. 15). Each of the lines 2b is an area in which a rectangular parallelepiped material is to be provided, which has a refractive index (e.g., lower than 1.5) lower than a refractive index (e.g., 1.5) of the light guiding area, i.e., the line 2a.

Examples of the rectangular parallelepiped material, which has a low refractive index and is to be provided in the line 2b, encompass a fluorine-containing resin, hollow fine particles, and dispersion resin.

FIG. 16 illustrates an example in which a plurality of rectangular parallelepiped switching elements are provided on a single substrate 40. Specifically, according to the rectangular parallelepiped switching element, a liquid crystal layer 42 is provided between two substrates 40, on each of which a plurality of rectangular parallelepiped electrodes 41 are provided so as to be juxtaposed to each other (see FIG. 16). When the two substrates 40 are combined with each other such that surfaces, on each of which the plurality of electrodes 41 are provided, face each other, the plurality of electrodes 41 form a parallel pattern. This allows switching to be made linearly.

Alternatively, a plurality of electrodes 41, each having a rectangular parallelepiped shape, can be provided on one of substrates 40 such that a line is formed between respective adjacent two of the plurality of electrodes 41 (see FIG. 17). It is possible that switching is carried out linearly on the one of the substrates 40 by carrying out planar switching.

The light control device of the present invention preferably further includes: control means (i) for sequentially controlling the plurality of light sources to emit respective lights and (ii) for controlling all the plurality of elements to adjust the ratios of the respective light-passage amounts during controlling of the plurality of light sources.

According to the configuration, the control means sequentially controls the plurality of light sources such that the plurality of light sources emit lights one by one, instead of controlling all the plurality of light sources to concurrently emit respective lights. This allows prevention of decrease in contrast.

In a case where, for example, all the plurality of light sources are controlled to emit their respective lights, light is guided to an area which is not a target area from which light comes out. In such a case, light sometimes slightly leaks out because the ratios of light-passage amount of the respective plurality of elements are not sufficiently adjusted. On the other hand, in the case of the present invention, only any one of the plurality light sources emits light, and therefore light hardly leaks out of an area which is not a target area from which light comes out, even in a case where the ratios of light-passage amount of the respective plurality of elements are not sufficiently adjusted. This allows an improvement (i) in contrast and (ii) in light use efficiency.

According to the configuration of the present invention, any of the plurality of light sources is controlled, instead of adjusting intensities of lights emitted from the respective plurality of light sources. It is therefore possible that all the plurality of light sources emit respective lights of identical intensities. In a case where, for example, an LED is used as a light source, it is necessary to prepare an expensive electric current control mechanism for adjusting intensity of light. Since all the plurality of light sources are necessary to emit respective lights of identical intensities, it is possible to simplify an electric current control mechanism for LEDs. This allows a reduction in cost.

According to the light control device of the present invention, it is preferable that the control means sequentially controls the plurality of light sources at 60 Hz or higher.

According to the configuration, the plurality of light sources are sequentially controlled, at an extremely high speed, i.e., at 60 Hz, such that light is emitted from any of the plurality of light sources. In the case where the sequential controlling is carried out at such a high speed, a human cannot visually distinguish between a lighting state and a non-lighting state. That is, the light emitting surface merely seems to emit light with arbitrary brightness and does not appear odd.

The light control device of the present invention preferably further includes: control means (i) for sequentially controlling the plurality of elements so as to adjust the ratios of the respective light-passage amounts and (ii) for controlling all the plurality of light sources to emit respective lights during controlling of the plurality of elements.

According to the configuration, the control means (i) sequentially controls the plurality of elements such that the ratios of light-passage amount of the respective plurality of elements are adjusted one by one and (ii) controls all the plurality of light sources to emit respective lights, instead of concurrently adjusting all the ratios of light-passage amount of the respective plurality of elements. Namely, the plurality of light sources are controlled to emit lights having respective intensities which vary depending on light exit areas, while the plurality of elements are sequentially being controlled to adjust the ratios of light-passage amount.

In a case where, for example, (i) a first element, which is being controlled, has a ratio of light-passage amount of 100% and (ii) a second element, which is not being controlled, has a ratio of light-passage amount of 0%, light exit areas on the first element are determined depending on intensities of lights emitted from the respective plurality of light sources. That is, since the plurality of light sources separately emit lights to the respective plurality of light guide paths, it is possible to control the plurality of light sources such that, for example, (i) only a light source is controlled to emit light to a light guide path corresponding to a light exit area and (ii) a light source is controlled not to emit light to a light guide path corresponding to a non-light exit area. This makes it possible to achieve a high contrast. Moreover, the lights, emitted from the respective plurality of light sources, are emitted outside only via the element which is being controlled. This makes it possible to achieve high light use efficiency.

According to the light control device of the present invention, it is preferable that the control means sequentially controls the plurality of elements at 60 Hz or higher.

According to the configuration, the plurality of elements are controlled at an extremely high speed, i.e., at 60 Hz. As such, even though light exit areas on the light emitting surface are gradually changed, a human cannot visually recognize such gradual changes. Instead, the light emitting surface seems to emit light with arbitrary brightness and does not appear odd.

According to the light control device of the present invention, it is preferable that, during controlling of the plurality of light sources, the control means controls the plurality of light sources to continuously emit lights having respective intensities which vary depending on respective amounts of lights, which are emitted via any one of the plurality of elements intersecting the plurality of light guide paths for which the respective plurality of light sources are provided.

According to the configuration, lights, which are emitted from the respective plurality of light guide paths, have respective intensities which are identical with those of lights emitted from the respective plurality of light sources corresponding to the respective plurality of light guide paths. With the configuration, it is possible to control the plurality of light sources to emit lights having respective desired intensities.

According to the light control device of the present invention, it is preferable that, in controlling of the plurality of light sources, the control means controls the plurality of light sources to continuously emit lights having identical intensities for respective time periods which vary depending on respective amounts of lights, which are emitted via any one of the plurality of elements intersecting the plurality of light guide paths for which the respective plurality of light sources are provided.

According to the configuration, amounts of lights, which exit via the element, are controlled by time periods during which the respective plurality of light sources emit lights. That is, the plurality of light sources emit lights having identical intensities, and respective time periods, during which the respective lights are continuously emitted, are adjusted so as to adjust the intensities of lights emitted from the respective plurality of light guide paths.

In a case where, for example, an LED is employed as the light source, the LED has high-speed response, and is therefore suitable for time division driving. The time division driving can be carried out by a control system which is less complicated than that for electric current driving, in which a light source is driven by controlling an electric current. This allows a reduction in cost of the control system.

According to the light control device of the present invention, it is preferable that the light guide means is a single light guide plate; and the plurality of light sources emit respective lights which have directivity in the longer side direction.

According to the configuration, even though the light guide means is a single light guide plate, the plurality of light sources emit respective lights which have directivity in a longer side direction of the light guide plate. This makes it possible to provide the plurality of light guide paths (i) which are juxtaposed to each other and (ii) each of which extends in the longer side direction of the light guide plate.

According to the light control device of the present invention, it is preferable that the light guide means is made up of a plurality of rectangular parallelepiped light guide plates which are juxtaposed to each other, the plurality of rectangular parallelepiped light guide plates having the respective plurality of light guide paths.

According to the configuration, light guide plates, in which lights emitted from the respective plurality of light sources are guided, are configured by the respective plurality of rectangular parallelepiped light guide plates, and therefore the lights emitted from the respective plurality of light sources are guided in accordance with the shapes of the light guide plates. It is therefore possible to design the plurality of light guide paths to have the respective rectangular parallelepiped shapes and to be juxtaposed to each other.

According to the light control device of the present invention, it is preferable that the light-passage amount adjusting means is a single plate on which the plurality of elements are provided.

According to the configuration, the light-passage amount adjusting means, on which the plurality of elements are provided, is a single plate. This makes it possible to simplify a manufacturing process.

According to the light control device of the present invention, it is preferable that the light-passage amount adjusting means is made up of a plurality of rectangular parallelepiped members, which are juxtaposed to each other and on which the respective plurality of elements are provided.

According to the configuration, the light-passage amount adjusting means, on which the plurality of elements are provided, is made up of the plurality of rectangular parallelepiped members which are separated from each other. With the configuration, it is possible to adjust a ratio of light-passage amount completely independently for each of lines of the plurality of elements.

The light control device of the present invention preferably further includes reflecting means for reflecting light, the reflecting means being provided on a surface of the light guide means, which surface is opposite to a light exit surface of the light guide means.

According to the configuration, light, which has been emitted from the light guide means to a surface opposite to the light exit surface, can be reflected by the reflecting means so that the light is sent to the light exit surface side. This achieves good light use efficiency.

The light control device of the present invention preferably further includes scattering means for scattering light, the scattering means being provided on a surface of the light guide means, which surface is opposite to a light exit surface of the light guide means.

According to the configuration, light, which has been diffused to the light guide means side by the plurality of elements, is scattered by the scattering means so that the light is sent to the light exit surface side again. This achieves good light use efficiency.

According to the light control device of the present invention, it is preferable that each of the plurality of elements is a liquid crystal element. With the configuration, it is possible to appropriately control a ratio of light-passage amount by utilizing a refractive index modulation characteristic of the liquid crystal element.

In order to attain the object, an image display device of the present invention includes the light control device of the present invention and a display panel provided on a light exit surface side of the light control device.

According to the configuration, the image display device of the present invention includes the light control device which can (i) control an arbitrary area on a plane to emit light and (ii) suppress a crosstalk. It is therefore possible to arbitrarily control luminance of an image to be displayed on the display panel. This allows an improvement in contrast.

The light control device of the present invention serves as a side emission type backlight. In a case where, for example, an LED is used as a light source of the light control device of the present invention, it is possible to provide a backlight extremely thinner than a direct type backlight. In a case where an active driving is carried out, for example, with respect to areas in the matrix arrangement of 5×5 (i.e., 25 areas), the conventional direct type backlight is required to control 25 LEDs for controlling the respective 25 areas. On the other hand, the image display device of the present invention needs to control only five light sources, which are included in the light control device. It is therefore possible to employ a simple control system, and accordingly cost can be reduced.

According to the image display device of the present invention, it is preferable that the display panel is a liquid crystal display panel. With the configuration, it is possible to appropriately display an image.

### EXAMPLE

The following description will discuss the present invention with the use of Example. Note, however, that the present invention is not limited to Example. In

Example, a light control device was prepared which (i) had a size of 30 cm×40 cm and (ii) had areas in a matrix arrangement of 5×5.

(Light Guide Plate and LED)

A plurality of acrylic plates having a width of 8 cm, a length of 30 cm, and a height of 4 mm, were transversely juxtaposed to each other at intervals of 0.1 mm as light guide plates. White LED chips, each of which had a height of 3.5 mm, a width of 7 mm, and a depth of 1.5 mm, were provided at respective end parts of the respective light guide plates. The five white LED chips were connected in series with the respective light guide plates. A light guide module was thus prepared. Note that a rated voltage was 18 V, and a rated electric current was 100 mA.

(Switching Element)

In Example, polymer dispersed liquid crystal was employed as a switching element. By sputtering, ITO (indium tin oxide) was deposited, as a transparent electrode material, by 100 nm on an acrylic substrate so that a transparent electrode is formed on the acrylic substrate, and then a polymer dispersed liquid crystal was applied, by 10 μm, onto the transparent electrode. A counter substrate was prepared by similarly depositing ITO, by 100 nm, on an acrylic substrate, by sputtering so that a transparent electrode is formed on the acrylic substrate. The two substrates were (i) combined such that the transparent electrodes are located between the two substrates and (ii) then hardened by ultraviolet. Five switching elements, each of which had a width of 6 cm and a length of 40 cm, were prepared one by one by the procedures above described. The five switching elements ware juxtaposed to each other at intervals of 0.1 mm, and a switching module was thus prepared.

(Light Control Device)

The light guide module and the switching module were provided so as to be perpendicular to each other and overlap each other. Matching oil was provided between the light guide module and the switching module so that light guided in the light guide module could enter the switching module. A scattering plate was provided on a side of the light guide module which side is opposite to a side on which the switching module was provided. A light control device of Example was thus prepared.

(Driving Method)

The light control device prepared as above described was driven by a method below.

In order to drive five lines (switching elements) in the switching module at a speed equivalent to 60 frames per second, the five switching elements were sequentially driven such that each of the five switching elements is turned ON for 3.7 milliseconds. In that case, an electric field was applied such that each of the five switching elements has an On state in which a scattering state becomes maximum, that is, in which an ON state of 100% is achieved.

The polymer dispersed liquid crystal prepared in Example had a characteristic in which a scattering state was saturated when a voltage of 60 V was applied. Therefore, by taking into account a distortion of voltage, an electric field of 100 V was applied across the polymer dispersed liquid crystal. In order to prevent burn-in, timings of switching were adjusted such that (i) +100V and −100V were alternately applied across the polymer dispersed liquid crystal and (ii) positive electric field caused by +100V and negative electric field caused by −100V always became an equilibrium state. That is, a polarity of each voltage was reversed for each frame. Note that each of the switching elements of Example was configured so as to be symmetric with respect to an electrode direction. Therefore, no difference in characteristic was caused by directions of the respective positive and negative electric fields.

Intensities of respective lights of the five white LED chips corresponding to respective lines of the light guide module were adjusted in sync with a selection of each of the lines of the switching module which were sequential driven. Specifically, the light control device of Example was controlled as the foregoing description discussed with reference to FIG. 5. That is, a line a of the switching module was turned ON and the five white LED chips corresponding to respective lines A through E of the light guide module were controlled to emit lights having respective intensities which vary depending on a continued luminance ratio of (0: 100: 200: 0: 500) so that the lines A through E intersecting the line a emit lights having the continued luminance ratio. As a result, it was possible to control the line a to emit lights having the respective intended luminances.

At the time, lines b through e of the switching module were each in an OFF state, that is, the lines b through e had a ratio of light-passage amount of 0%. No light was therefore emitted from each of the lines b through e. Subsequently, the lines b through e were sequentially controlled in a similar manner, and the five white LED chips were controlled to emit lights having respective intensities required for the respective lines A through E. As a result, lights, having respective intended luminances, could be emitted from the respective areas in the matrix arrangement of 5×5. The switching module was controlled at a speed equivalent to 60 frames per second, and therefore the areas in the matrix arrangement of 5×5, as a whole, were viewed as lighting at an arbitrary brightness.

An image display device was prepared which included, as a backlight, the light control device prepared in Example. Specifically, the light control device of Example was provided behind a general TFT liquid crystal display panel having a size of 20 inches. The light control device was driven in sync with driving of the liquid crystal display panel. Note that light emitting patterns of the light control device were adjusted in accordance with an image displayed on the liquid crystal display panel. As a result, the image could be displayed with a high contrast.

In general, a commonly used LED direct type active backlight has a thickness of approximately 3 cm. On the other hand, the light control device of Example had a thickness of not thicker than 5 mm. It was therefore possible to provide a thin image display device.

According to Example, the areas in the matrix arrangement of 5×5 (i.e., 25 areas) were controlled. In a case where an LED direct type backlight is controlled for such 25 areas, the LED direct type backlight needs to separately control all the 25 areas. On the other hand, the light control device of Example needed to control only (i) the five lines in the switching module and (ii) the five lines in the light guide module. In particular, it is merely necessary to control each of the lines in the switching module to be turned ON or OFF by the sequential control. That is, it was substantially required to control merely the five white LED chips, without providing a complicated mechanism. Therefore, a simple control system could be employed, and accordingly cost of the backlight could be reduced.

The present invention is not limited to the embodiments, but can be altered by a skilled person in the art within the scope of the claims. An embodiment derived from a proper combination of technical means disclosed in respective different embodiments is also encompassed in the technical scope of the present invention.

### INDUSTRIAL APPLICABILITY

The present invention is suitably employed as a backlight of a display device included in a device such as a personal digital assistance, a mobile phone, a personal computer, or a television set.

### REFERENCE SIGNS LIST

1: Light control device

2: Light guide plate (light guide means)

3: LED (light source)

4: Switching element (element)

5: Reflecting plate (reflecting means)

6: Diffusing plate

7: Matching oil

10: Image display device

11: Display panel

1. A light control device comprising:
light guide means, which has a plurality of light guide paths (i) each of which has a rectangular parallelepiped shape and (ii) which are juxtaposed to each other, for guiding light, which has entered an end part on a side of a shorter side of each of the plurality of light guide paths, in a longer side direction of the each of the plurality of light guide paths;
a plurality of light sources, provided at the respective end parts, for emitting lights toward the respective plurality of light guide paths; and
light-passage amount adjusting means for adjusting ratios of light-passage amount of the light guide means, the light-passage amount adjusting means (i) being provided on a light exit surface side of the light guide means and (ii) having a plurality of elements which allow ratios of light-passage amount of the light guide means to be adjustable, the plurality of elements (a) each having a rectangular parallelepiped shape, (b) each extending in a direction perpendicular to the longer side direction, and (c) being juxtaposed to each other in the longer side direction.

2. A light control device as set forth in claim 1, further comprising:
control means (i) for sequentially controlling the plurality of light sources to emit respective lights and (ii) for controlling all the plurality of elements to adjust the ratios of the respective light-passage amounts during controlling of the plurality of light sources.

3. The light control device as set forth in claim 2, wherein:
the control means sequentially controls the plurality of light sources at 60 Hz or higher.

4. A light control device as set forth in claim 1, further comprising:
control means (i) for sequentially controlling the plurality of elements so as to adjust the ratios of the respective light-passage amounts and (ii) for controlling all the plurality of light sources to emit respective lights during controlling of the plurality of elements.

5. The light control device as set forth in claim 4, wherein:
the control means sequentially controls the plurality of elements at 60 Hz or higher.

6. The light control device as set forth in claim 4, wherein:
during controlling of the plurality of light sources, the control means controls the plurality of light sources to continuously emit lights having respective intensities which vary depending on respective amounts of lights, which are emitted via any one of the plurality of elements intersecting the plurality of light guide paths for which the respective plurality of light sources are provided.

7. The light control device as set forth in claim 4, wherein:
in controlling of the plurality of light sources, the control means controls the plurality of light sources to continuously emit lights having identical intensities for respective time periods which vary depending on respective amounts of lights, which are emitted via any one of the plurality of elements intersecting the plurality of light guide paths for which the respective plurality of light sources are provided.

8. The light control device as set forth in claim 1, wherein:
the light guide means is a single light guide plate; and
the plurality of light sources emit respective lights which have directivity in the longer side direction.

9. The light control device as set forth in claim 1, wherein:
the light guide means is made up of a plurality of rectangular parallelepiped light guide plates which are juxtaposed to each other, the plurality of rectangular parallelepiped light guide plates having the respective plurality of light guide paths.

10. The light control device as set forth in claim 1, wherein:
the light-passage amount adjusting means is a single plate on which the plurality of elements are provided.

11. The light control device as set forth in claim 1, wherein:
the light-passage amount adjusting means is made up of a plurality of rectangular parallelepiped members, which are juxtaposed to each other and on which the respective plurality of elements are provided.

12. A light control device as set forth in claim 1, further comprising:
reflecting means for reflecting light, the reflecting means being provided on a surface of the light guide means, which surface is opposite to a light exit surface of the light guide means.

13. A light control device as set forth in claim 1, further comprising:
scattering means for scattering light, the scattering means being provided on a surface of the light guide means, which surface is opposite to a light exit surface of the light guide means.

14. The light control device as set forth in claim 1, wherein:
each of the plurality of elements is a liquid crystal element.

15. An image display device comprising:
a light control device recited in claim 1; and
a display panel provided on a light exit surface side of the light control device.

16. The image display device as set forth in claim 15, wherein:
the display panel is a liquid crystal display panel
